(19) United States
(12) Patent Application Publication
(10) Pub. No.: US 2025/0203533 A1
(43) Pub. Date: Jun. 19, 2025

(54) USER EQUIPMENT POWER SHARING MECHANISMS IN DUAL CONNECTIVTY

(71) Applicant: SHARP KABUSHIKI KAISHA, Osaka (JP)

(72) Inventor: TOMOKI YOSHIMURA, Camas, WA (US)

(21) Appl. No.: 18/540,172

(22) Filed: Dec. 14, 2023

(51) Int. Cl. H04W 52/36; H04L 5/14; H04W 52/42; H04W 76/20

(52) U.S. Cl. CPC H04W 52/367; H04L 5/14; H04W 52/42; H04W 76/20

(57) ABSTRACT

A user equipment (UE) that includes one or more non-transitory computer-readable media storing one or more computer-executable instructions for determining the transmission power of the UE and at least one processor coupled to the one or more non-transitory computer-readable media is provided. The processor is configured to execute the one or more computer-executable instructions to cause the UE to determine that a subband full duplex (SBFD) resource in a downlink slot of a master cell group (MCG) overlaps, at least partially, an uplink resource in a uplink slot of a Secondary Cell Group (SCG) in time domain; and determine the transmission power of the uplink resource based on a maximum available transmission power associated with the SCG.

### TECHNICAL FIELD

The technology generally relates to wireless communications, and more particularly, to user equipment (UE) dual connectivity power sharing mechanisms.

### BACKGROUND

With the tremendous growth in the number of connected devices and the rapid increase in user/network (NW) traffic volume, various efforts have been made to improve different aspects of wireless communication for next-generation wireless communication systems, such as fifth-generation (5G) New Radio (NR), by improving data rate, latency, reliability, and mobility.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation wireless communication systems.

### SUMMARY

In a first aspect of the present application, a UE is provided. The UE includes one or more non-transitory computer-readable media storing one or more computer-executable instructions for determining the transmission power of the UE. The UE further includes at least one processor coupled to the one or more non-transitory computer-readable media and configured to execute the one or more computer-executable instructions to cause the UE to determine that a subband full duplex (SBFD) resource in a downlink (DL) slot of a master cell group (MCG) overlaps, at least partially, an uplink (UL) resource in a UL slot of a Secondary Cell Group (SCG) in time domain; and determine the transmission power of the UL resource based on a maximum available transmission power associated with the SCG. A maximum available transmission power of the UE is greater than or equal to a sum of a maximum available transmission power associated with the MCG and the maximum available transmission power associated with the SCG.

In an implementation of the first aspect, the UL slot of the SCG is a first UL slot of the SCG, the at least one processor is further configured to execute the one or more instructions to cause the UE to determine that there is no overlap between a UL resource in a second DL slot of the SCG and any resource in a UL slot, a flexible slot, or an SBFD slot of the MCG in time domain; and determine the transmission power of the UL resource in the second slot of the SCG based on a maximum available transmission power of the UE without using the maximum available transmission power associated with the SCG.

In another implementation of the first aspect, the flexible slot is used for either transmitting UL resources or receiving DL resources, and the SBFD slot divides the UL and DL resources in one slot allowing simultaneous transmission of data to, and receiving of data from, the MCG in the SBFD slot using a frequency domain modulation (FDM).

In another implementation of the first aspect, a maximum available transmission power of the UE is greater than or equal to a sum of a maximum available transmission power associated with the MCG and the maximum available transmission power associated with the SCG.

In another implementation of the first aspect, the at least one processor is further configured to execute the one or more instructions to cause the UE to receive the maximum available transmission power associated with the MCG from a base station (BS) in a first radio resource control (RRC) message; and receive the maximum available transmission power associated with the SCG from the BS in a second RRC message.

In another implementation of the first aspect, the DL slot includes a time division duplex (TDD) pattern slot of the MCG, and the UL slot includes a TDD pattern slot of the SCG.

In another implementation of the first aspect, determining the transmission power of the UL resource includes determining the transmission power of the UL resource as a function of the maximum available transmission power associated with the SCG, a target transmission power for one physical resource block (PRB), and a number of PRBs allocated for UL transmission.

In another implementation of the first aspect, the MCG and SCG are out of sync.

In a second aspect of the present application, a UE is provided. The UE includes one or more non-transitory computer-readable media storing one or more computer-executable instructions for determining a transmission power of the UE. The UE further includes at least one processor coupled to the one or more non-transitory computer-readable media and configured to execute the one or more computer-executable instructions to cause the UE to determine that a SBFD resource in a DL slot of a SCG overlaps, at least partially, a UL resource in a UL slot of an MCG in time domain; and determine the transmission power of the UL resource based on a maximum available transmission power associated with the MCG. A maximum available transmission power of the UE is greater than or equal to a sum of the maximum available transmission power associated with the MCG and a maximum available transmission power associated with the SCG.

In an implementation of the first aspect, the UL slot of the MCG is a first UL slot of the MCG, the at least one processor is further configured to execute the one or more instructions to cause the UE to determine that there is no overlap between a UL resource in a second DL slot of the MCG and any resource in a UL slot, a flexible slot, or an SBFD slot of the SCG in time domain; and determine the transmission power of the UL resource in the second slot of the MCG based on a maximum available transmission power of the UE without using the maximum available transmission power associated with the MCG.

In another implementation of the first aspect, the flexible slot is used for either transmitting UL resources or receiving DL resources, and the SBFD slot divides the UL and DL resources in one slot allowing simultaneous transmission of data to, and receiving of data from, the SCG in the SBFD slot using an FDM.

In another implementation of the first aspect, a maximum available transmission power of the UE is greater than or equal to a sum of a maximum available transmission power associated with the MCG and the maximum available transmission power associated with the SCG.

In another implementation of the first aspect, the at least one processor is further configured to execute the one or more instructions to cause the UE to receive the maximum available transmission power associated with the MCG from a BS in a RRC message; and receive the maximum available transmission power associated with the SCG from the BS in a second RRC message.

In another implementation of the first aspect, the DL slot includes a TDD pattern slot of the SCG, and the UL slot includes a TDD pattern slot of the MCG.

In another implementation of the first aspect, determining the transmission power of the UL resource includes determining the transmission power of the UL resource as a function of the maximum available transmission power associated with the MCG, a target transmission power for one PRB, and a number of PRBs allocated for UL transmission.

In another implementation of the first aspect, the MCG and SCG are out of sync.

In a third aspect of the present application, a method of determining how to share a maximum transmission power of a UE is provided. The method includes determining that a SBFD resource in a DL slot of a MCG overlaps, at least partially, a UL resource in a UL slot of an SCG in time domain; and determining the transmission power of the UL resource based on a maximum available transmission power associated with the SCG. A maximum available transmission power of the UE is greater than or equal to a sum of a maximum available transmission power associated with the MCG and the maximum available transmission power associated with the SCG.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a wireless communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a time-frequency diagram illustrating an example resource partitioning in a serving cell, according to an example implementation of the present disclosure.

FIG. 9 is a time-frequency diagram illustrating an example resource partitioning in a serving cell, according to an implementation of the present disclosure.

FIG. 10 illustrates an example of the MCG and SCG TDD patterns in dual connectivity mode.

FIG. 11 illustrates an example of the MCG and SCG TDD patterns with SBFD operation in a downlink slot of the MCG in dual connectivity mode, according to an example implementation of the present disclosure.

FIG. 12 is a flowchart illustrating an example method/process performed by a terminal device to determine the transmission power of the uplink transmission for the SCG when the MCG includes at least one SBFD slot, according to an example implementation of the present disclosure.

FIG. 13 illustrates an example of the MCG and SCG TDD patterns with SBFD operation in a downlink slot of the SCG in dual connectivity mode, according to an example implementation of the present disclosure.

FIG. 14 is a flowchart illustrating an example method/process performed by a terminal device to determine the transmission power of the uplink transmission for the MCG when the SCG includes at least one SBFD slot, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and case of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may be formed of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present application, a UE (or terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A base station may include, but is not limited to, a node B (NB) as in the UMTS, an evolved node B (CNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)\hat{ }(IX) indicates IX to the power of HX.

According to one aspect of the present embodiment, a waveform formed based on the OFDM may be used in a wireless communication system. An OFDM symbol defines a unit in the time domain of the waveform. Each OFDM symbol is converted to a time-continuous signal during a baseband signal generation. For example, the CP-OFDM may be used in the downlink direction of the wireless communication system. For example, either CP-OFDM or Discrete Fourier Transform-spread-Orthogonal Frequency Division Multiplex (DFT-s-OFDM) may be used in the uplink direction of the wireless communication system.

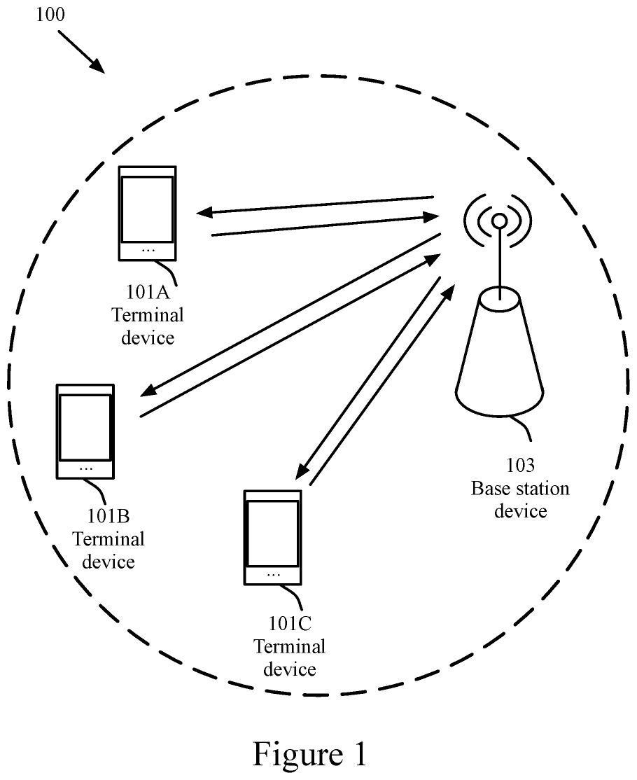

FIG. 1 is a schematic diagram illustrating a wireless communication system, according to an example implementation of the present disclosure. In FIG. 1, the wireless communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured of multiple transmission/reception devices, each of the multiple transmission/reception devices may be arranged at a different position. A transmission/reception device may include a transmission device and/or a reception device.

BS 103 may be configured to serve wireless communication by providing one or more cells. A cell is defined as a set of resources used for a wireless communication. A cell may include one or both of a downlink component carrier and an uplink component carrier. A serving cell may include a downlink component carrier and two or more uplink component carriers. A downlink component carrier and an uplink component carrier are also referred to as component carriers.

One or more SCS-specific carriers may be associated with one component carrier. Each SubCarrier Spacing-specific (SCS-specific) carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

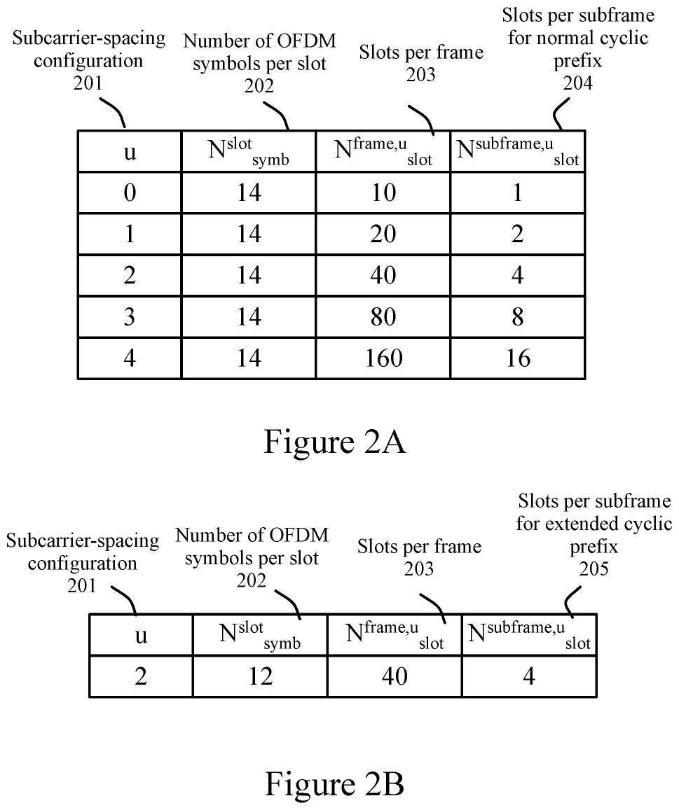

FIGS. 2A and 2B are two diagrams illustrating parameters related to subcarrier spacing (SCS)-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame, u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In FIG. 2A, for example, when the subcarrier-spacing configuration u 201 is set to 2 and the CP configuration is set to normal CP (Cyclic Prefix), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

Time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(df_{ref}N_{f, ref}). The constant k is 64 when df_{ref} is 15 kHz and N_{f, ref} is 2048.

Transmission of signals in the downlink and/or transmission of signals in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame includes ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

SCS of the OFDM-based waveform may be calculated by subcarrier-spacing configuration u. For example, the SCS may be calculated by 15000*2^{u}.

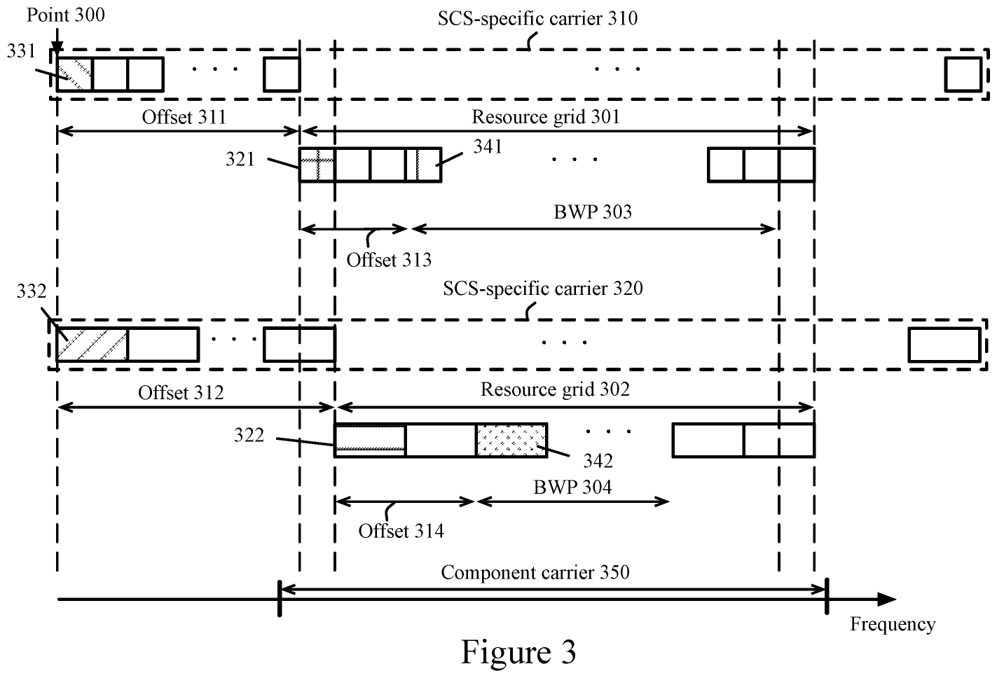

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for identifying a subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point A.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

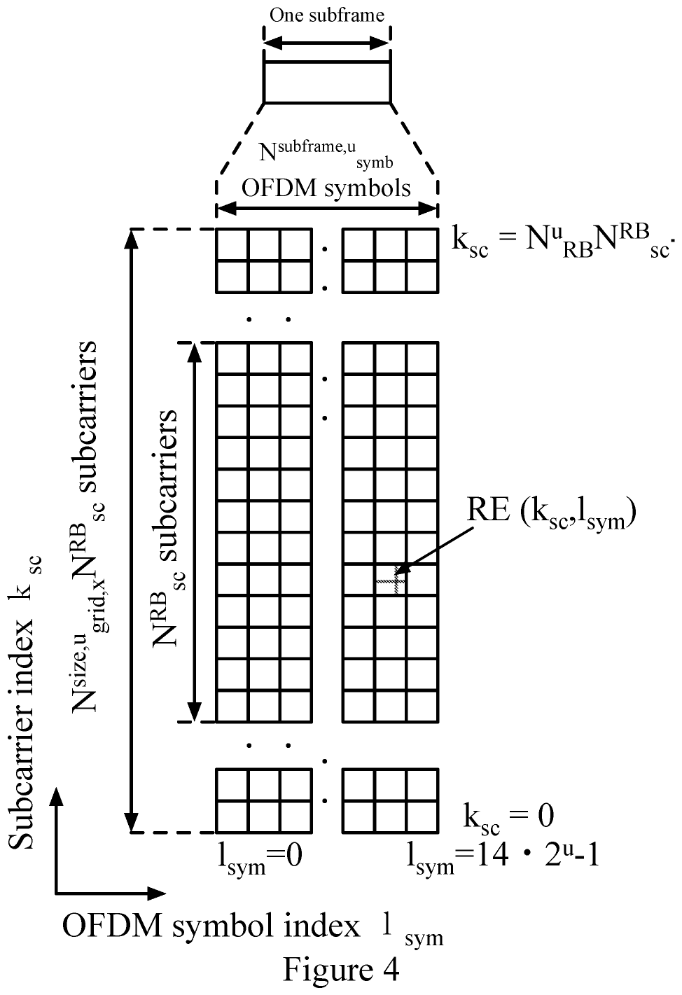

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid1},xN^{RB}_{sc} subcarriers and N^{subframes,u}_{symb} OFDM symbols. A resource specified by the subcarrier index k_{sc} and the OFDM symbol index l_{sym} in a resource grid is also referred to as RE (Resource Element).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} is 12. CRBs are indexed in ascending order starting at CRB with index 0. PRBs are indexed in ascending order starting at its reference point of the BWP. A BWP is defined as a subset of resource blocks included in the resource grid. The BWP includes N^{size, u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

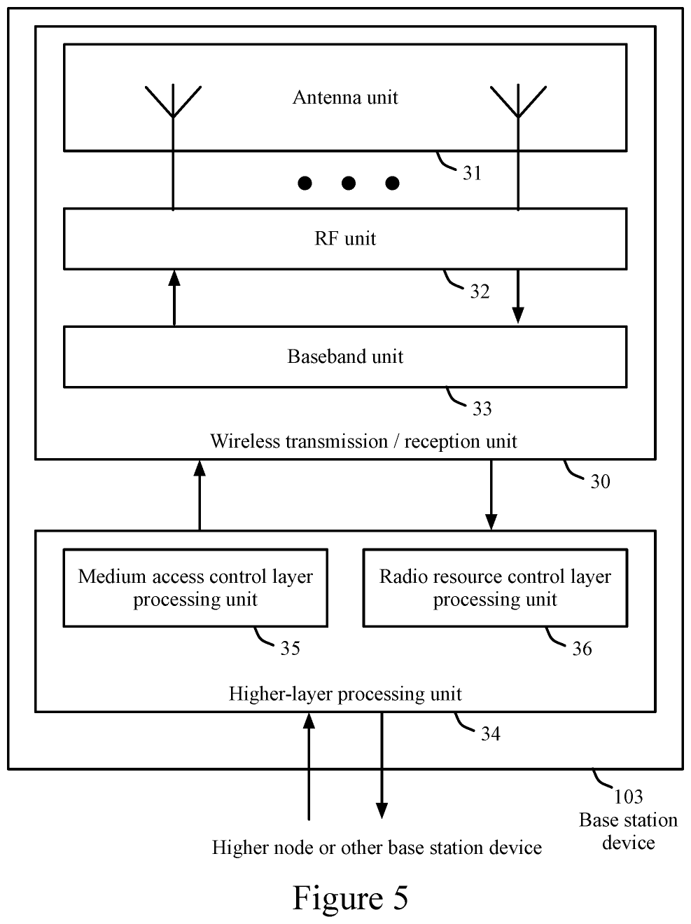

FIG. 5 is a schematic block diagram illustrating a configuration example of a base station device 103, according to an example implementation of the present disclosure. As shown in FIG. 5, the base station device 103 may include a part or all of the wireless transmission and reception unit (or physical layer processing unit) 30 and a higher-layer processing unit 34. The wireless transmission and reception unit 30 (also referred to herein as the wireless transmission/reception unit) may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

From the terminal device 101's perspective, serving cells are cells which provide wireless communication services. Serving cells may be any of a PCell, a PSCell, and an SCell. A PCell represents a serving cell in a Master Cell Group (MCG). A PCell is a serving cell which is used for an initial connection establishment procedure or a connection re-establishment procedure by the terminal device 101.

A PSCell represents a serving cell included in a Secondary Cell Group (SCG). A PSCell is a serving cell in which a random-access procedure is performed by the terminal device 101. An SCell represents a serving cell which is different from a PCell and a PSCell. A serving cell group represents a designation including at least an MCG and an SCG. The serving cell group includes one or more serving cells.

The terminal device 101 configures one or more downlink BWPs per serving cell. The terminal device 101 configures one or more uplink BWPs per serving cell.

The terminal device 101 receives or tries to detect a Physical Downlink Shared Channel (PDSCH), a Physical Downlink Control Channel (PDCCH), and a Channel State Information-Reference Signal (CSI-RS) in the active downlink BWP. The terminal device 101 transmits a Physical Uplink Control Channel (PUCCH) and a Physical Uplink Shared Channel (PUSCH) in the active uplink BWP. The active downlink BWP and the active uplink BWP are also referred to as active BWP.

The terminal device 101 does not receive the PDSCH, PDCCH, and CSI-RS in the downlink BWPs other than the active downlink BWP. The terminal device 101 does not transmit the PUCCH and PUSCH in the uplink BWPs other than the active uplink BWP. BWPs other than the active BWP is referred to as inactive BWPs.

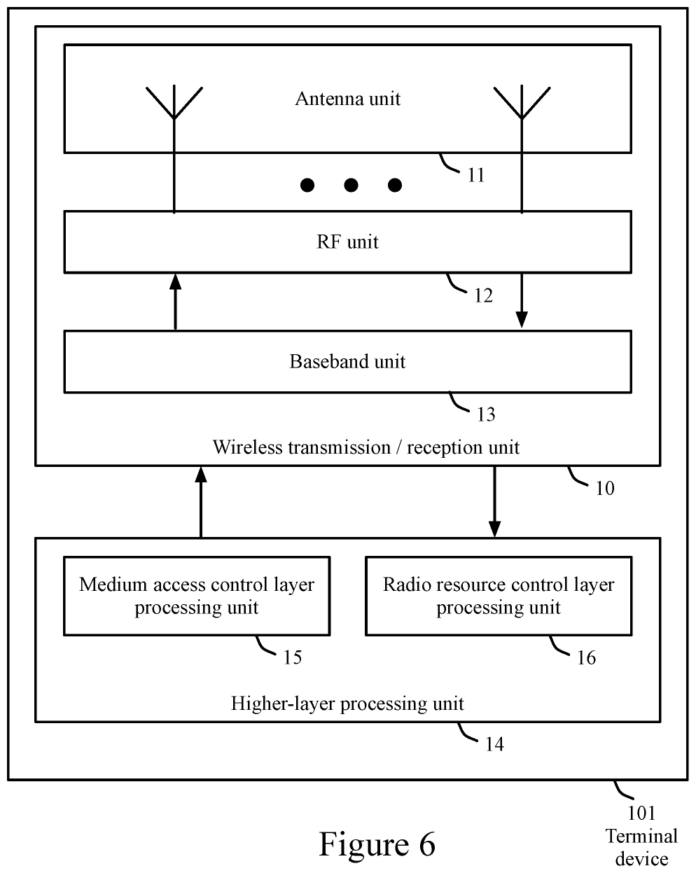

FIG. 6 is a schematic block diagram illustrating a configuration example of a terminal device, according to an example implementation of the present disclosure. As shown in FIG. 6, the terminal device 101 may include a part or all of the wireless transmission and reception unit (e.g., physical layer processing unit) 10 and the higher-layer processing unit 14. The wireless transmission and reception unit 10 (also referred to herein as wireless transmission/reception unit) may include a part or all of the antenna unit 11, the RF unit 12, and the Baseband unit 13. The higher-layer processing unit 14 may include a part or all of the MAC layer processing unit 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 included in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 performs processing of the MAC layer, the PDCP layer, the RLC layer, and/or the RRC layer.

The MAC layer processing unit 15 in the higher-layer processing unit 14 performs processing of the MAC layer. RRC layer processing unit 16 in the higher-layer processing unit 14 performs the process of the RRC layer. RRC layer processing unit 16 manages various RRC parameters of the terminal device 101 based on RRC messages received from the base station device 103.

The wireless transmission and reception unit 10 (or the wireless transmission unit 10a) performs processing, such as encoding and modulation. The wireless transmission and reception unit 10 (or the wireless transmission unit 10a) generates a physical signal by encoding and modulating the uplink data. The wireless transmission and reception unit 10 (or the wireless transmission unit 10a) converts OFDM symbols in the physical signal to a baseband signal by conversion to a time-continuous signal. The wireless transmission and reception unit 10 (or the wireless transmission unit 10a) transmits the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) separates, demodulates and decodes the received physical signal, and provides the decoded information to the higher-layer processing unit 14. The wireless transmission and reception unit 10 (or the wireless reception unit 10b) may perform the channel access procedure prior to the transmission of the physical signal.

The RF unit 12 demodulates the radio signal received via the antenna unit 11 into an analog signal, and/or removes extra frequency components. The RF unit 12 provides the processed analog signal to the baseband unit 13. The baseband unit 13 converts the analog signal input from RF unit 12 into a baseband signal. The baseband unit 13 separates a portion which corresponds to CP from the baseband signal, performs FFT on the baseband signal from which the CP has been removed. The baseband unit 13 extracts components of the physical signal from the baseband signal.

The baseband unit 13 performs IFFT on the uplink data to generate time-continuous signal, adds a CP to the generated signal, generates a baseband signal, and convert the baseband signal into an analog signal. The baseband unit 13 provides the analog signal to the RF unit 12.

The RF unit 12 removes extra frequency components from the analog signal input from the baseband unit 13, up-converts the analog signal to a radio frequency, and transmits it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the wireless communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access preamble. A PRACH may be sent to deliver (transmit, convey) an index of a random-access preamble. the terminal device 101 may transmit a PRACH. The base station device 103 may receive the PRACH.

For a given PRACH opportunity, 64 random-access preambles are defined. The random-access preamble is specified (determined, given) based on the cyclic shift Cᵥ of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UL DMRS (UpLink Demodulation Reference Signal), SRS (Sounding Reference Signal), UL PTRS (UpLink Phase Tracking Reference Signal) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and DCI (Downlink Control Information). In the wireless communication system according to one aspect of the present embodiment, a part or all of PBCH (Physical Broadcast Channel), PDCCH (Physical Downlink Control Channel), and PDSCH (Physical Downlink Shared Channel) may be used.

A PBCH may be used to transmit a MIB (Master Information Block). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

DCI format includes a set of information fields. Each information field masks a bit sequence for the DCI. Bits masked by an information field is associated with a specific meaning associated with the information field.

Several DCI formats may be used in the wireless communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a FDRA (Frequency Domain Resource Assignment) field. Information field 1C is a TDRA (Time Domain Resource Assignment) field. Information field 1D is a frequency-hopping flag field. Information field 1E is an MCS (Modulation-and-Coding-Scheme) field.

A DCI format identification field indicates whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format is used to indicate assignment of frequency resources for a physical channel scheduled by the DCI format.

A TDRA field in a DCI format is used to indicate assignment of time resources for a physical channel scheduled by the DCI format.

A frequency-hopping flag field in a DCI format is used to indicate whether frequency-hopping is applied to a physical channel scheduled by the DCI format.

A MCS field in a DCI format is used to indicate one or both of a modulation scheme for a physical channel scheduled by the DCI format and a target code rate for the physical channel. The target code rate is used to determine a TBS (Transport Block Size) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 determines that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 determines that active BWP change has not been triggered by the DCI format.

DCI format 0_1 is used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 0_1 indicates that the DCI format 0_1 is an uplink DCI format.

The CSI request field is used to request CSI reporting.

If the DCI format 0_1 includes a BWP field, the BWP field is used to indicate an uplink BWP on which a PUSCH scheduled by the DCI format 0_1 is mapped.

If the DCI format 0_1 includes the carrier indicator field, the carrier indicator field is used to indicate an uplink component carrier on which a PUSCH is mapped.

DCI format 1_0 is used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field is used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field is used to indicate a PUCCH resource.

The DCI format 1_0 may not include the carrier indicator field. If a downlink DCI format does not include the carrier indicator field, the terminal device 101 determines that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 is used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 1_1 indicates that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 receives the physical downlink signal. In the wireless communication system according to one aspect of the present embodiment, at least a part or all of an SS (Synchronization signal), DL DMRS (DownLink DeModulation Reference Signal), CSI-RS (Channel State Information-Reference Signal), and DL PTRS (DownLink Phase Tracking Reference Signal) may be used.

A synchronization signal is used to synchronize in the frequency domain and time domain for downlink. The synchronization signal is a generic name of PSS (Primary Synchronization Signal) and SSS (Secondary Synchronization Signal).

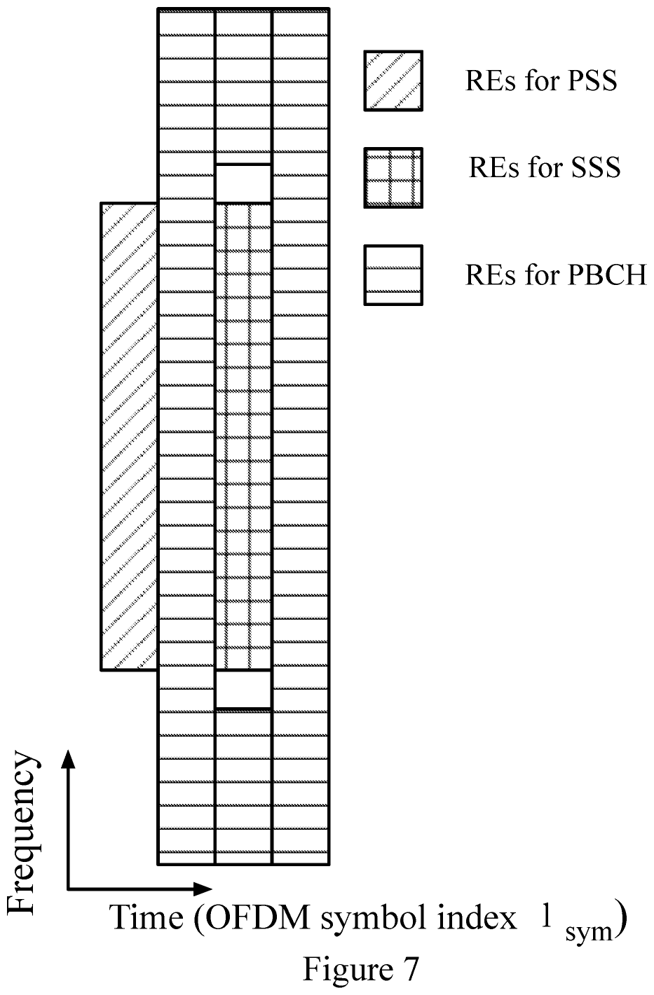

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index l_{sym}, and the vertical axis represents the frequency domain. The shaded blocks represent a set of REs for the PSS. The block of grid lines represents a set of REs for the SSS. Also, the blocks in the horizontal line represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block is identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A BCH (Broadcast CHannel), a UL-SCH (Uplink-Shared CHannel) and a DL-SCH (Downlink-Shared CHannel) are transport channels. A channel used in the MAC layer is called a transport channel. A unit of transport channel used in the MAC layer is also called transport block (TB) or MAC PDU (Protocol Data Unit). In the MAC layer, control of HARQ (Hybrid Automatic Repeat request) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A BCCH (Broadcast Control CHannel), a CCCH (Common Control CHannel), and a DCCH (Dedicated Control CHannel) are logical channels. The BCCH is a channel of the RRC layer used to deliver MIB or system information. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The base station device 103 may indicate change of cell-specific parameters by reconfiguration with random-access. The base station device 103 may indicate change of UE-specific parameters by reconfiguration with or without random-access.

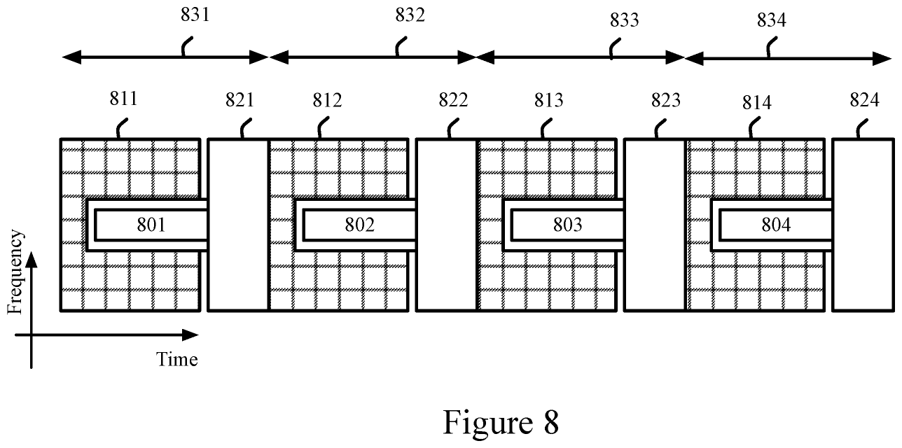

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the TDD pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern is configured based on one or more RRC parameters provided by the RRC layer.

The UL subband is configured in one or both of the DL region and the time domain guard period. The time domain resource of the UL subband is configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3^{rd} slot, and the length is 11 slots, the terminal device 101 determines that the UL subband with length of 11 slots starting at the 3^{rd} slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped (e.g., is allocated/assigned) is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

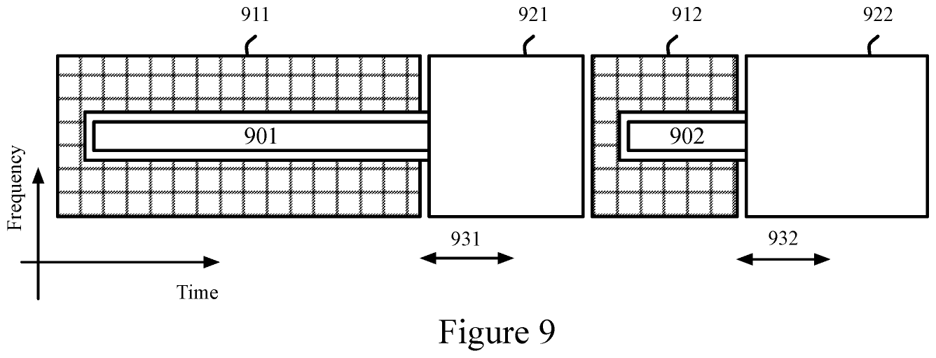

FIG. 9 is a time-frequency diagram illustrating an example resource partitioning in a serving cell, according to an implementation of the present disclosure. The horizontal axis represents the time domain. The vertical axis represents the frequency domain. The regions 901 and 902 represent the time-frequency resources for a UL subband. The regions 911 and 912 with grid lines represent the DL regions. The regions 921 and 922 represent the UL regions.

In some implementations, when the terminal device 101 changes its configuration in an aperiodic manner, the base station device 103 may not know at which time the terminal device 101 changed its configuration. On the other hand, when the terminal device 101 switches its configuration, a gap duration may exist during which the terminal device 101 may not be able to transmit and receive physical signals. For example, when the terminal device 101 is changing its configuration at the end of duration 911 from the SBFD configuration to a normal configuration, the terminal device 101 may process the change in the duration 931 of FIG. 9. Also, when the terminal device is changing its configuration at the end of duration 912 from the SBFD configuration to a normal configuration, the terminal device 101 may process the change in duration 932.

In a dual connectivity mode, the terminal device 101 may be connected to an MCG and an SCG. Power sharing mechanisms in the two cell groups may be required, particularly when the two cell groups are out of sync. Dual connectivity is operatable in a case that the two cell groups are connected with non-ideal backhaul. In some of the existing networks, a power sharing mechanism based on TDD patterns is employed.

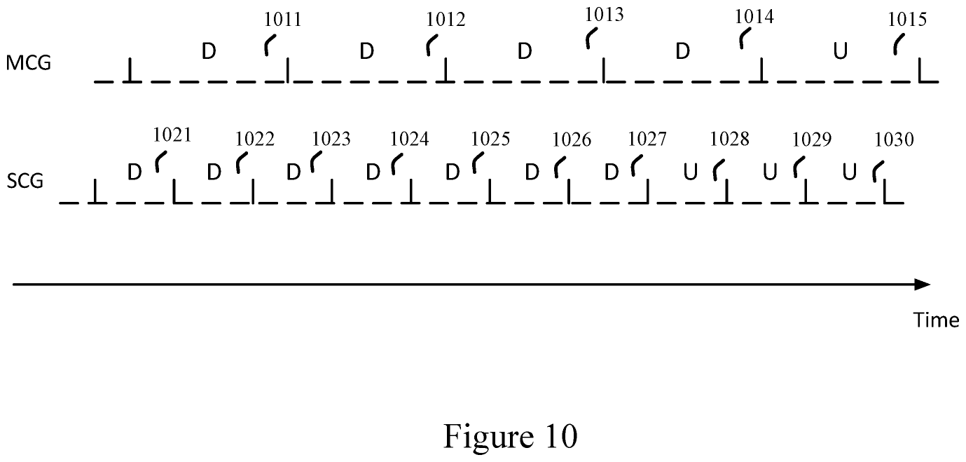

FIG. 10 illustrates an example of the MCG and SCG TDD patterns in dual connectivity mode. With reference to FIG. 10, the grids represent slots. In SCG, slot durations are shorter than the slot durations in the MCG. In some networks, such as 5G NR, the difference of the slot length for the MCG and SCG may come from different subcarrier spacings.

In the example of FIG. 10, a TDD pattern of DDDDU is employed in the MCG, where “D” represents a downlink slot (e.g., the slots 1011-1014) and “U” represents an uplink slot (e.g., the slot 1015). In the SCG, a TDD pattern of DDDDDDDUUU is employed, where the slots 1021-1027 are downlink slots and the slots 1028-1030 are uplink slots.

Power sharing may be done using the TDD configurations in the MCG and SCG. For example, in the uplink slot 1028 in the SCG, maximum available transmission power Pmax may be allocated to the SCG since there is no uplink resource (e.g., associated with the MCG) that overlaps with the uplink slot 1028. On the other hand, the uplink slots 1029 and 1030 in the SCG overlap, at least partially, with the uplink slot 1015 in the MCG. Therefore, the maximum available transmission power Pmax should be divided when the uplink slot in one cell group overlaps, at least partially, an uplink slot in a different cell group. In some networks, such as 5G NR, power allocation to different cells groups may be configurable. For example, the BS may configure the maximum available transmission power associated with the MCG (P_{MCG}) and the maximum available transmission power associated with the SCG (P_{SCG}) via RRC signaling (e.g., through two separate RRC parameters). The RRC parameters, for example, may be received from the RRC layer of the terminal device. In some implementations, Pmax is greater than or equal to the sum of P_{MCG} and P_{SCG}.

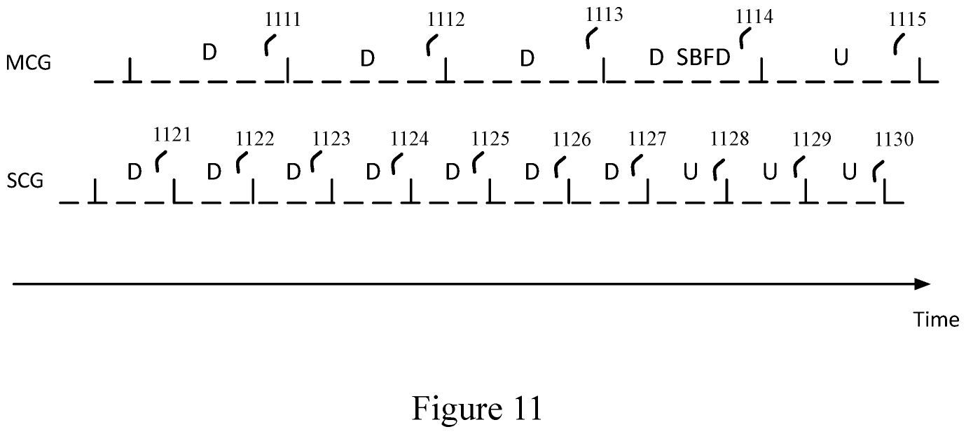

The network in the example of FIG. 10 does not use SBFD slots. In an SBFD operation, additional uplink resources are inserted in downlink slots. Therefore, the above power sharing mechanism based on the TDD pattern may not be applicable or desirable. FIG. 11 illustrates an example of the MCG and SCG TDD patterns with an SBFD operation in a downlink slot of the MCG in dual connectivity mode, according to an example implementation of the present disclosure.

In the example of FIG. 11, a TDD pattern of DDDDU is employed in the MCG, where the slots 1111-1114 are downlink slots and the slot 1115 is an uplink slot. In the SCG, a TDD pattern of DDDDDDDUUU is employed, where the slots 1121-1127 are downlink slots and the slots 1128-1130 are uplink slots. In the example of FIG. 11, the downlink slot 1114 is an SBFD downlink slot.

The downlink SBFD slot 1114 divides the downlink resource and the uplink resource in one slot using frequency-division multiplexing (FDM). Therefore, the uplink slot 1128 in the SCG fully overlaps an SBFD resource (e.g., an uplink resource in the downlink SBFD slot 1114) in the MCG. Additionally, the UL slot 1129 also overlaps, at least partially, the SBFD resource. Therefore, power sharing mechanisms between uplink slots and SBFD slots need to be defined.

In some implementations, the following procedure may be applied to determine the transmission power of the uplink transmission for the SCG when the MCG includes at least one SBFD slot. If an uplink transmission in an SCG overlaps with an SBFD slot in an MCG, the transmission power of the SCG uplink transmission should be determined based on P_{SCG}.

Conversely, if an uplink transmission in an SCG does not overlap with an SBFD slot, an uplink slot, or a flexible slot in an MCG, the transmission power of the SCG uplink transmission is determined without using P_{SCG} (e.g., the transmission power of the SCG uplink transmission may be determined based on the maximum transmission power (Pmax) of the terminal device).

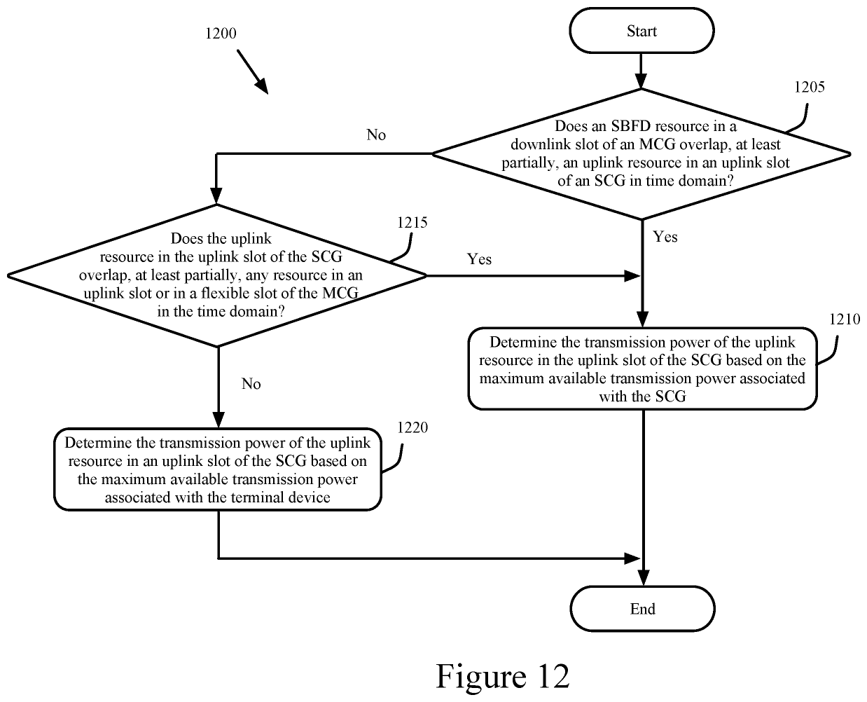

FIG. 12 is a flowchart illustrating an example method/process 1200 performed by a terminal device to determine the transmission power of the uplink transmission for the SCG when the MCG includes at least one SBFD slot, according to an example implementation of the present disclosure.

With reference to FIG. 12, the process 1200 may be performed by at least one processor of the terminal device 101A-101C of FIG. 1 or the terminal device 101 of FIG. 6. At block 1205, a determination may be made as to whether an SBFD resource in a downlink slot of an MCG overlaps, at least partially, an uplink resource in an uplink slot of an SCG in time domain. For example, the terminal device may determine that there is at least a partial time overlap between an SBFD resource in a downlink slot (such as the downlink slot 1114 of FIG. 11) of the MCG and an uplink resource in an uplink slot (such as the uplink slot 1128 of FIG. 11) of an SCG. The SBFD slot is a downlink slot that divides the uplink and downlink resources in one slot to allow simultaneous transmission of data to, and receiving of data from, the MCG cell group in the SBFD slot using FDM.

When there is at least a partial time overlap between the SBFD resource in the downlink slot of the MCG and the uplink resource in the uplink slot of the SCG, the transmission power of the uplink resource in the uplink slot of the SCG may be determined (at block 1210) based on the maximum available transmission power associated with the SCG. For example, the transmission power of the uplink resource in the uplink slot of the SCG may be determined based on the P_{SCG}. The process 1200 may then end.

The P_{MCG} and the P_{SCG} may be configurable parameters. For example, in some embodiments, the terminal device may receive the maximum available transmission power associated with the MCG from the BS in a first radio resource control (RRC) message and may receive the maximum available transmission power associated with the SCG from the BS in a second RRC message. It should be noted that the P_{MCG} and the P_{SCG} serve as the maximum power of respective cell groups and the terminal device may use the P_{MCG} and P_{SCG} based on different criteria to determine the actual transmission power of an uplink resource. For example, the transmission power of a PUSCH transmission P_{PUSCH} may be calculated as P_{PUSCH}=max(P_{CG}, P₀+10·log₁₀ M), where P_{CG} is either P_{MCG} or P_{SCG}, P₀ is the target transmission power for one PRB (Physical Resource Blocks), and M is the number of PRBs allocated for the PUSCH. In this calculation, power is increased linearly by the number of PRBs. In this example, the expression of the transmission power is made in log scale and the unit of the power is dB.

Referring back to FIG. 12, when there is no time overlap between the SBFD resource in the downlink slot of the MCG and the uplink resource in the uplink slot of the SCG, the determination may be made (at block 1215) as to whether the uplink resource in the uplink slot of the SCG overlaps, at least partially, any resource in an uplink slot or in a flexible slot of the MCG in the time domain. A flexible slot is a TDD slot that may be used for either transmitting UL resources or receiving DL resources.

When the uplink resource in the uplink slot of the SCG at least partially overlaps any resource in an uplink slot or in a flexible slot of the MCG in the time domain, the process 1200 may proceed to block 1210, which was described above.

Otherwise, the transmission power of the uplink resource in an uplink slot of the SCG may be determined (at block 1220) based on the maximum available transmission power associated with the terminal device. The process 1200 may then end.

It should be noted that, for a network that does not use SBFD slots (e.g., as described above with reference to FIG. 10), whenever an uplink slot of one cell group overlaps a downlink slot of another cell group, the terminal device does not have to share the transmission power between the uplink and the downlink slots during the overlap period, as the downlink slot is not used to transmit any uplink resource. On the other hand, the SBFD slot is an exception case where a downlink slot with SBFD allows simultaneous transmission of data to, and receiving of data from, the cell group and, therefore, requires allocation of transmission power. The implementations of the present embodiments provide the technical advantage of providing transmission power sharing between an uplink slot of one cell group (e.g., the SCG, or the MCG) and a downlink slot of another cell group (e.g., the MCG or the SCG).

It should be noted that the sum of P_{MCG} and P_{SCG} may not always be equal to Pmax. The BS (e.g., the gNB), in some situations, may require flexibility in configuring the power allocation. For example, simultaneous uplink transmission in the MCG and SCG may lead to some additional power losses. As such, the maximum available transmission power of the UE, Pmax, may be greater than or equal to the sum of the maximum available transmission power associated with the MCG, P_{MCG}, and the maximum available transmission power associated with the SCG, P_{SCG}. In addition, it should be noted that the values P_{MCG} and P_{SCG} may be different when two uplink slots overlap or when an uplink slot and an SBFD slot overlap.

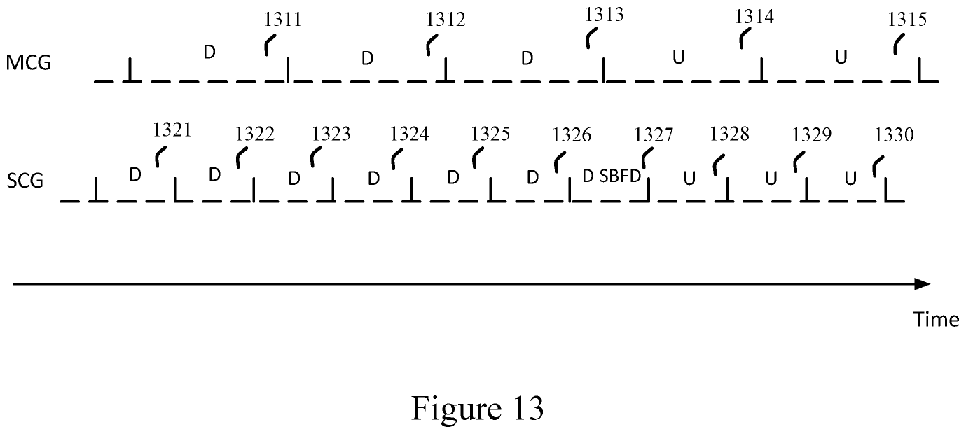

The example of FIG. 11 described a scenario where there is an SBFD slot in the TDD pattern slot of the MCG. In other implementations, the SBFD slot may be in a TDD pattern slot of the SCG. FIG. 13 illustrates an example of the MCG and SCG TDD patterns with SBFD operation in a downlink slot of the SCG in dual connectivity mode, according to an example implementation of the present disclosure.

In the example of FIG. 13, a TDD pattern of DDDUU is employed in the MCG, where the slots 1311-1313 are downlink slots and the slots 1314-1315 are uplink slots. In the SCG, a TDD pattern of DDDDDDDUUU is employed, where the slots 1321-1327 are downlink slots and the slots 1328-1330 are uplink slots. In the example of FIG. 13, the downlink slot 1327 is an SBFD downlink slot.

The downlink SBFD slot 1327 divides the downlink resource and the uplink resource in one slot in an FDM manner. Therefore, the uplink slot 1314 in the MCG also overlaps with an uplink resource in the downlink SBFD slot 1327 in the SCG. Therefore, the terminal device may define power sharing mechanisms between uplink slots and SBFD slots.

In some implementations, the following procedure may be applied to determine the transmission power of the uplink transmission for the MCG when the SCG includes at least one SBFD slot. If an uplink transmission in an MCG overlaps with an SBFD slot in an SCG, the transmission power of the MCG uplink transmission should be determined based on P_{MCG}. Conversely, if an uplink transmission in an MCG does not overlap with an SBFD slot, an uplink slot, or a flexible slot in an SCG, the transmission power of the MCG uplink transmission should be determined without using P_{MCG} (e.g., the transmission power of the MCG uplink transmission may be determined based on the maximum transmission power (Pmax) of the terminal device).

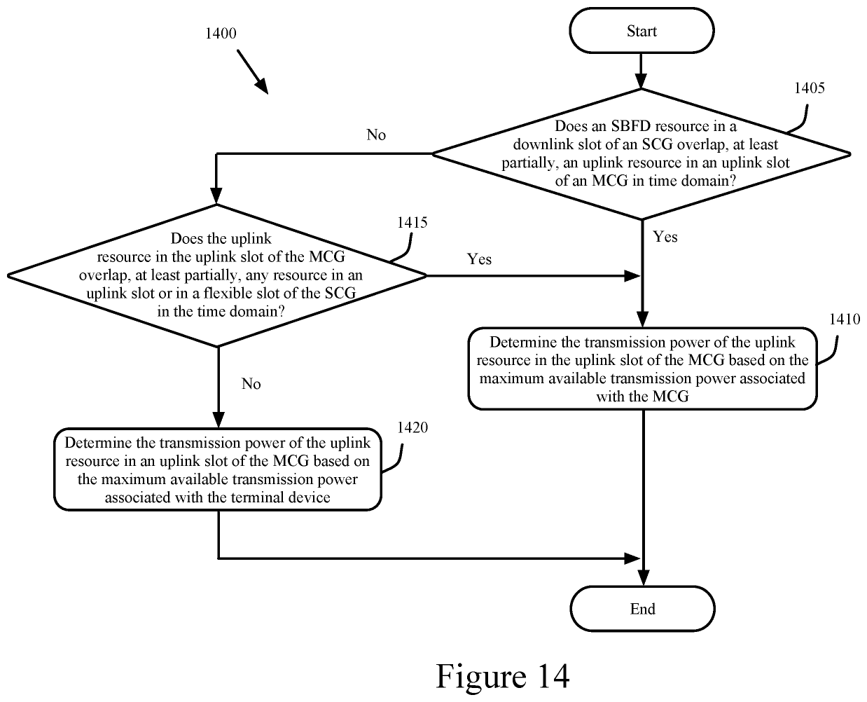

FIG. 14 is a flowchart illustrating an example method/process 1400 performed by a terminal device to determine the transmission power of the uplink transmission for the MCG when the SCG includes at least one SBFD slot, according to an example implementation of the present disclosure.

With reference to FIG. 14, the process 1400 may be performed by at least one processor of the terminal device 101A-101C of FIG. 1 or the terminal device 101 of FIG. 6. At block 1405, a determination may be made as to whether an SBFD resource in a downlink slot of an SCG overlaps, at least partially, an uplink resource in an uplink slot of an MCG in time domain. For example, the terminal device may determine that there is at least a partial time overlap between an SBFD resource in a downlink slot (such as the downlink slot 1327 of FIG. 13) of the SCG and an uplink resource in an uplink slot (such as the uplink slot 1314 of FIG. 13) of an MCG. The SBFD slot, in the example of FIG. 13, is a downlink slot that divides the uplink and downlink resources in one slot to allow simultaneous transmission of data to, and receiving of data from, the SCG cell group in the SBFD slot using FDM.

When there is at least a partial time overlap between the SBFD resource in the downlink slot of the SCG and the uplink resource in the uplink slot of the MCG, the transmission power of the uplink resource in the uplink slot of the MCG may be determined (at block 1410) based on the maximum available transmission power associated with the MCG. For example, the transmission power of the uplink resource in the uplink slot of the MCG may be determined based on the P_{MCG}. The process 1400 may then end.

As described above, the P_{MCG} and the P_{SCG} may be configurable parameters. For example, in some embodiments, the terminal device may receive the maximum available transmission power associated with the MCG from BS in a first RRC message and may receive the maximum available transmission power associated with the SCG from the BS in a second RRC message. It should be noted that the P_{MCG} and the P_{SCG} serve as the maximum power of respective cell groups and the terminal device may use the P_{MCG} and P_{SCG} based on different criteria to determine the actual transmission power of an uplink resource. For example, the transmission power of a PUSCH transmission P_{PUSCH} may be calculated as P_{PUSCH}=max(P_{CG}, P₀+10·log₁₀ M), where P_{CG} is either P_{MCG} or P_{SCG}, P₀ is the target transmission power for one PRB (Physical Resource Blocks), and M is the number of PRBs allocated for the PUSCH. In this calculation, power is increased linearly by the number of PRBs. In this example, the expression of the transmission power is made in log scale and the unit of the power is dB.

Referring back to FIG. 14, when there is no time overlap between the SBFD resource in the downlink slot of the SCG and the uplink resource in the uplink slot of the MCG, the determination may be made (at block 1415) as to whether the uplink resource in the uplink slot of the MCG overlaps, at least partially, any resource in an uplink slot or in a flexible slot of the SCG in the time domain. As described above, a flexible slot is a TDD slot that may be used for either transmitting UL resources or receiving DL resources.

When the uplink resource in the uplink slot of the MCG at least partially overlaps any resource in an uplink slot or in a flexible slot of the SCG in the time domain, the process 1400 may proceed to block 1410, which was described above.

Otherwise, the transmission power of the uplink resource in an uplink slot of the MCG may be determined (at block 1420) based on the maximum available transmission power associated with the terminal device. The process 1400 may then end.

It should be noted that, for a network that does not use SBFD slots (e.g., as described above with reference to FIG. 10), whenever an uplink slot of one cell group overlaps a downlink slot of another cell group, the terminal device does not have to share the transmission power between the uplink and the downlink slots during the overlap period, as the downlink slot is not used to transmit any uplink resource. On the other hand, the SBFD slot is an exception case where a downlink slot with SBFD allows simultaneous transmission of data to, and receiving of data from, the cell group and, therefore, requires allocation of transmission power. The implementations of the present embodiments provide the technical advantage of allowing transmission power sharing between an uplink slot of one cell group (e.g., SCG, or MCG) and a downlink slot of another cell group (e.g., the MCG or the SCG).

It should be noted that the sum of P_{MCG} and P_{SCG} may not always be equal to Pmax. The BS (e.g., the gNB), in some situations, may require flexibility in configuring the power allocation. For example, simultaneous uplink transmission in MCG and SCG may lead to some additional power losses. As such, the maximum available transmission power of the UE, Pmax, may be greater than or equal to the sum of the maximum available transmission power associated with the MCG, P_{MCG}, and the maximum available transmission power associated with the SCG, P_{SCG}. In addition, it should be noted that the values P_{MCG} and P_{SCG} may be different when two uplink slots overlap and when an uplink slot and an SBFD slot overlap.

The various foregoing example embodiments and modes may be utilized in conjunction with one another, e.g., in combination with one another.

Each of a program running on the base station device 103 and the terminal device 101 according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 101 and the base station device 103 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 101 or the base station device 103, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station device 103 according to the above-described embodiment may be achieved as an aggregation (a device group) including multiple devices. Each of the devices configuring such a device group may include some or all of the functions or the functional blocks of the base station device 103 according to the above-described embodiment. The device group may include each general function or each functional block of the base station device 103. Furthermore, the terminal device 101 according to the above-described embodiment can also communicate with the base station device as the aggregation.

Furthermore, the base station device 103 according to the above-described embodiment may serve as an Evolved Universal Terrestrial Radio Access Network (E-UTRAN) and/or NG-RAN (Next Gen RAN, NR-RAN). Furthermore, the base station device 103 according to the above-described embodiment may have some or all of the functions of a node higher than an eNodeB or the gNB.

Furthermore, some or all portions of each of the terminal device 101 and the base station device 103 according to the above-described embodiment may be typically achieved as an LSI which is an integrated circuit or may be achieved as a chip set. The functional blocks of each of the terminal device 101 and the base station device 103 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device 101 has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for determining a transmission power of the UE; and
at least one processor coupled to the one or more non-transitory computer-readable media, and configured to execute the one or more computer-executable instructions to cause the UE to:
determine that a subband full duplex (SBFD) resource in a downlink (DL) slot of a master cell group (MCG) overlaps, at least partially, an uplink (UL) resource in a UL slot of a Secondary Cell Group (SCG) in time domain; and
determine the transmission power of the UL resource based on a maximum available transmission power associated with the SCG,
wherein a maximum available transmission power of the UE is greater than or equal to a sum of a maximum available transmission power associated with the MCG and the maximum available transmission power associated with the SCG.

2. The UE of claim 1, wherein the UL slot of the SCG is a first UL slot of the SCG, wherein the at least one processor is further configured to execute the one or more instructions to cause the UE to:
determine that there is no overlap between a UL resource in a second DL slot of the SCG and any resource in a UL slot, a flexible slot, or an SBFD slot of the MCG in time domain; and
determine the transmission power of the UL resource in the second slot of the SCG based on a maximum available transmission power of the UE without using the maximum available transmission power associated with the SCG.

3. The UE of claim 2, wherein:
the flexible slot is used for either transmitting UL resources or receiving DL resources, and
the SBFD slot divides the UL and DL resources in one slot allowing simultaneous transmission of data to, and receiving of data from, the MCG group in the SBFD slot using frequency-division multiplexing (FDM).

4. The UE of claim 1, wherein the at least one processor is further configured to execute the one or more instructions to cause the UE to:
receive the maximum available transmission power associated with the MCG from a base station (BS) in a first radio resource control (RRC) message; and
receive the maximum available transmission power associated with the SCG from the BS in a second RRC message.

5. The UE of claim 1, wherein:
the DL slot comprises a time division duplex (TDD) pattern slot of the MCG, and
the UL slot comprises a TDD pattern slot of the SCG.

6. The UE of claim 1, wherein determining the transmission power of the UL resource comprises determining the transmission power of the UL resource as a function of the maximum available transmission power associated with the SCG, a target transmission power for one physical resource block (PRB), and a number of PRBs allocated for UL transmission.

7. The UE of claim 1, wherein the MCG and SCG are out of sync.

8. A user equipment (UE), comprising:
one or more non-transitory computer-readable media storing one or more computer-executable instructions for determining a transmission power of the UE; and
at least one processor coupled to the one or more non-transitory computer-readable media, and configured to execute the one or more computer-executable instructions to cause the UE to:
determine that a subband full duplex (SBFD) resource in a downlink (DL) slot of a Secondary Cell Group (SCG) overlaps, at least partially, an uplink (UL) resource in a UL slot of a master cell group (MCG) in time domain; and
determine the transmission power of the UL resource based on a maximum available transmission power associated with the MCG,
wherein a maximum available transmission power of the UE is greater than or equal to a sum of the maximum available transmission power associated with the MCG and a maximum available transmission power associated with the SCG.

9. The UE of claim 8, wherein the UL slot of the MCG is a first UL slot of the MCG, wherein the at least one processor is further configured to execute the one or more instructions to cause the UE to:
determine that there is no overlap between a UL resource in a second DL slot of the MCG and any resource in a UL slot, a flexible slot, or an SBFD slot of the SCG in time domain; and
determine the transmission power of the UL resource in the second slot of the MCG based on a maximum available transmission power of the UE without using the maximum available transmission power associated with the MCG.

10. The UE of claim 9, wherein:
the flexible slot is used for either transmitting UL resources or receiving DL resources, and
the SBFD slot divides the UL and DL resources in one slot allowing simultaneous transmission of data to, and receiving of data from, the SCG in the SBFD slot using frequency-division multiplexing (FDM).

11. The UE of claim 8, wherein, wherein the at least one processor is further configured to execute the one or more instructions to cause the UE to:
receive the maximum available transmission power associated with the MCG from a base station (BS) in a first radio resource control (RRC) message; and
receive the maximum available transmission power associated with the SCG from the BS in a second RRC message.

12. The UE of claim 8, wherein:
the UL slot comprises a time division duplex (TDD) pattern slot of the MCG; and
the DL slot comprises a TDD pattern slot of the SCG.

13. The UE of claim 8, wherein determining the transmission power of the UL resource comprises determining the transmission power of the UL resource as a function of the maximum available transmission power associated with the MCG, a target transmission power for one physical resource block (PRB), and a number of PRBs allocated for UL transmission.

14. The UE of claim 8, wherein the MCG and SCG are out of sync.

15. A method of determining a transmission power of the UE a user equipment (UE), the method comprising:
determining that a subband full duplex (SBFD) resource in a downlink (DL) slot of a master cell group (MCG) overlaps, at least partially, an uplink (UL) resource in a UL slot of a Secondary Cell Group (SCG) in time domain; and
determining the transmission power of the UL resource based on a maximum available transmission power associated with the SCG,
wherein a maximum available transmission power of the UE is greater than or equal to a sum of a maximum available transmission power associated with the MCG and the maximum available transmission power associated with the SCG.
